(19) United States
(12) Patent Application Publication
(10) Pub. No.: US 2012/0079814 A1
(43) Pub. Date: Apr. 5, 2012

(54) EXHAUST GAS RECIRCULATION SYSTEM

(76) Inventor: Micael Blomquist, Kvissleby (SE)

(21) Appl. No.: 13/376,892

(22) PCT Filed: Jun. 11, 2009
(86) PCT No.: PCT/SE2009/050713

§ 371 Date: Dec. 8, 2011

(51) Int. Cl. F02M 25/07; F01N 3/023

(52) U.S. Cl. 60/278

(57) ABSTRACT

An exhaust gas recirculation system (10) for recirculating exhaust gases from an exhaust conduit (9) of a combustion engine (1), particularly a large combustion engine having an engine power of 500 kW or more, to an air intake (3) thereof, which system comprises:—two or more particulate filters (12a, 12b) arranged in parallel with each other;—valve means (17) for selectively switching the respective filter between an active state and an inactive state, the valve means being configured to allow exhaust gases to pass from the exhaust conduit to the air intake through a filter which is in the active state and to prevent exhaust gases from passing from the exhaust conduit to the air intake through a filter which is in the inactive state; and—filter regeneration means (40) for selectively initiating a regeneration of the respective filter when the filter is in the inactive state.

### FIELD OF THE INVENTION AND PRIOR ART

The present invention relates to an exhaust gas recirculation system for recirculating exhaust gases from an exhaust conduit of a combustion engine, particularly a large combustion engine having an engine power of 500 kW or more, to an air intake thereof.

There is today a growing desire to reduce the emission of substances that are hazardous to the environment, such as for instance NOₓ. Thus, there is a growing demand for a system that can be used with a large combustion engine in order to reduce the content of NOₓ in the exhaust gases that are released into the free air from an exhaust conduit of the engine.

A large combustion engine having an engine power of 500 kW or more may for instance be connected to a generator in order to produce electric power in a train or ship or at a power plant. Such a combustion engine is substantially larger than a conventional diesel engine of a road vehicle and therefore generates substantially larger amounts of exhaust gases as compared to such a conventional diesel engine. This will make heavy demands on the equipment to be used for purifying the exhaust gases from such a large combustion engine and it will normally not be possible to use standard exhaust gas purifying components dimensioned for use with a conventional diesel engine of a road vehicle.

There are two main techniques in use today for reducing the content of NOₓ in the exhaust gases from a conventional diesel engine of a road vehicle, namely the SCR catalyst technique (SCR=Selective Catalytic Reduction) and the EGR technique (EGR=Exhaust Gas Recirculation). The SCR catalyst technique is the most effective technique but suffers from the drawback that an SCR catalyst designed for use with a large combustion engine will be very large and bulky. Another drawback with the SCR catalyst technique is that large reservoirs are required for storing the reducing agent required for the operation of the SCR catalyst. The EGR technique is less effective than the SCR catalyst technique and has so far not come into use for large combustion engines having an engine power of 500 kW or more.

### SUMMARY OF THE INVENTION

The object of the present invention is to provide a favourable solution for purifying the exhaust gases from a combustion engine, particularly from a large combustion engine having an engine power of 500 kW or more.

According to the invention, this object is achieved by an exhaust gas recirculation system having the features defined in claim 1.

The exhaust gas recirculation system of the invention is to be used for recirculating exhaust gases from an exhaust conduit of a combustion engine to an air intake thereof, and comprises:
a filter arrangement for removing particulate constituents from exhaust gases passing through the recirculation system from the exhaust conduit to the air intake of the engine, the filter arrangement comprising two or more particulate filters arranged in parallel with each other;
valve means for selectively switching the respective filter between an active state and an inactive state, the valve means being configured to allow exhaust gases to pass from the exhaust conduit to the air intake of the engine through a filter which is in the active state and to prevent exhaust gases from passing from the exhaust conduit to the air intake of the engine through a filter which is in the inactive state; and
filter regeneration means for selectively initiating a regeneration of the respective filter when the filter is in the inactive state.

By having the particulate filters arranged in the exhaust gas recirculation system and not in the ordinary exhaust conduit from the engine, it will be possible to use particulate filters of reduced size. When the exhaust gas recirculation system of the invention is used for purifying the exhaust gases from a large combustion engine having an engine power of 500 kW or more, it will be possible to use particulate filters of the type and dimension presently used in exhaust conduits from diesel engines in road vehicles. This is due to the fact that the recirculated exhaust gas flow in an exhaust gas recirculation system of a large combustion engine having an engine power of 500 kW or more normally will be of approximately the same magnitude as the exhaust gas flow in the exhaust conduit from a conventional diesel engine in a road vehicle. Thus, standard particulate filters can be used, which will contribute to comparatively low installation and maintenance costs and reduced space requirements. Furthermore, by using two or more parallel particulate filters, a filter may be regenerated while one or more other filters are in operation. Hereby, a filter can be regenerated at the same time as the recirculation system continues to operate normally.

Further advantages as well as advantageous features of the invention will appear from the following description and the dependent claims.

### BRIEF DESCRIPTION OF THE DRAWING

With reference to the appended drawing, a specific description of preferred embodiments of the invention cited as examples follows below. In the drawing:

FIG. 1 is a schematic planar view from above of a combustion engine provided with an exhaust gas recirculation system according to an embodiment of the present invention.

### DETAILED DESCRIPTION OF PREFERRED EMBODIMENTS OF THE INVENTION

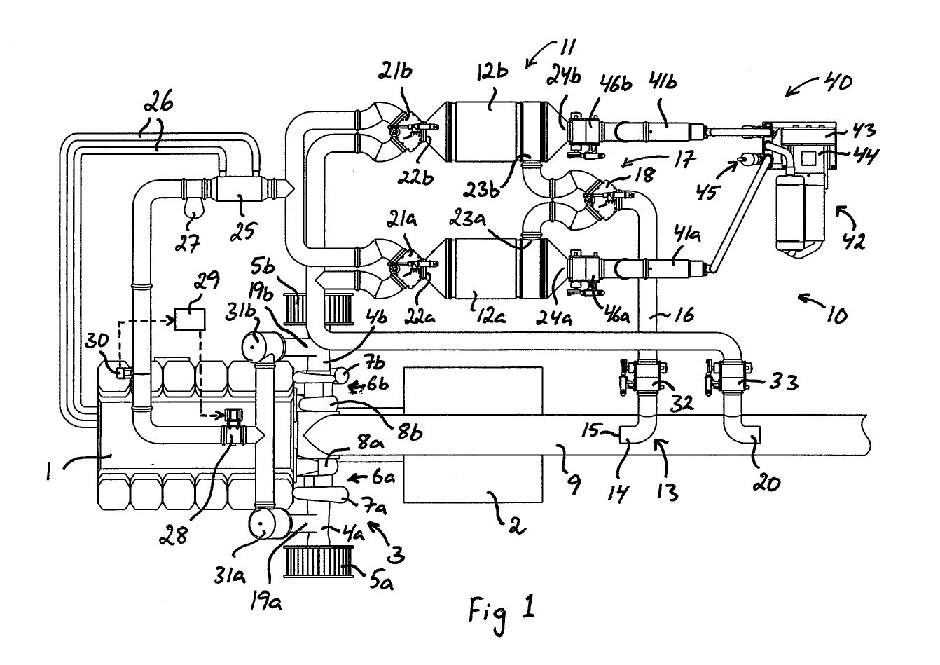

A combustion engine 1 is illustrated in FIG. 1. In the illustrated example, the combustion engine 1 is a large diesel engine, but it could alternatively be a large gas engine. In the illustrated example, the output shaft of the engine 1 is connected to a generator 2, which is driven by the engine in order to produce electric power.

The engine 1 is provided with an air intake 3, through which combustion air is fed into the engine. In the illustrated example, the air intake 3 comprises two air inlet channels 4a, 4b, each of which being provided with an air filter 5a, 5b.

In the illustrated example, the engine 1 is provided with turbo chargers 6a, 6b in order to achieve supercharging, i.e. forced air supply to the engine. A first turbo charger 6a comprises a compressor wheel 7a arranged in a first one 4a of the air inlet channels, and a second turbo charger 6b comprises a compressor wheel 7b arranged in the other air inlet channel 4b. The respective compressor wheel 7a, 7b is driven by an associated turbine wheel 8a, 8b, which is arranged to be driven in rotation by exhaust gases from the engine 1. The compressor wheel 7a, 7b and the turbine wheel 8a, 8b of the respective turbo charger 6a, 6b are operably connected to each other, e.g. by being placed on one and the same shaft. As an alternative, the flow of air into the engine 1 through the air inlet channels 4a, 4b may be achieved without any turbo chargers, i.e. merely by the suction caused by piston movements in the engine.

An exhaust conduit 9 is connected to the engine 1. The exhaust gases produced by the engine 1 are conducted through the exhaust conduit 9 and the main part thereof enters into the surroundings via an exhaust gas outlet (not shown) connected to the exhaust conduit. An exhaust gas recirculation system 10 is provided for recirculating exhaust gases from the exhaust conduit 9 to the air intake 3.

The recirculation system 10 comprises a filter arrangement 11 for removing particulate constituents from exhaust gases passing through the recirculation system from the exhaust conduit 9 to the air intake 3. In the illustrated example, the filter arrangement 11 comprises a first particulate filter 12a and a second particulate filter 12b arranged in the recirculation system 10 in parallel with each other. The filter arrangement may however, if so desired, comprise more than two particulate filters arranged in parallel with each other in the recirculation system. The respective filter 12a, 12b has such a filtering efficiency that it is capable of catching particulate constituents to such an extent that the exhaust gases, after having passed through the filter, are sufficiently filtered for being recirculated to the air intake 3 of the engine and introduced into the engine 1 without causing any damages to the engine. The filters 12a, 12b constitute so-called diesel particulate filters.

The recirculation system 10 comprises an inlet 13 for receiving exhaust gases from the exhaust conduit 9. The inlet 13 comprises a pick-up tube 14, which is arranged in the exhaust conduit 9 with its inlet opening 15 directed against the intended flowing direction of exhaust gases flowing through the exhaust conduit. The exhaust gases entering the recirculation system through the inlet 13 are directed through a conduit 16 towards the filters 12a, 12b.

The recirculation system 10 comprises valve means 17 for selectively switching the respective filter 12a, 12b between an active state and an inactive state. The valve means 17 are configured to allow exhaust gases to pass from the exhaust conduit 9 to the air intake 3 through a filter which is in the active state and to prevent exhaust gases from passing from the exhaust conduit 9 to the air intake 3 through a filter which is in the inactive state. The valve means 17 are preferably configured to switch one of said filters 12a, 12b from active to inactive state while simultaneously switching the other one of said filters from inactive to active state.

In the illustrated example, said valve means 17 comprise a valve device 18, which is arranged in the conduit 16 between the inlet 13 and the filters 12a, 12b in order to direct the exhaust flow in the conduit 16 to one of the filters 12a, 12b while preventing the exhaust flow in the conduit 16 from reaching the other filter. Thus, the valve device 18 is configured to set one filter at a time in communication with the intake 13 while disconnecting the other filter from the intake 13.

The recirculation system 10 comprises two first outlets 19a, 19b connected to the air intake 3 of the engine 1 for discharging recirculated exhaust gases to the air intake. One 19a of said first outlets is connected to the first air inlet channel 4a and the other one 19b of said first outlets is connected to the second air inlet channel 4b. The recirculation system 10 also comprises a second outlet 20 connected to the exhaust conduit 9 downstream of the inlet 13 for discharging combustion gases produced during the regeneration of the respective filter 12a, 12b to the exhaust conduit. In the illustrated example, a valve device 21a, 21b is arranged downstream of the respective filter 12a, 12b in order to selectively set the outlet 22a, 22b of the filter in communication with the first outlets 19a, 19b of the recirculation system or with the second outlet 20 of the recirculation system.

The recirculation system 10 comprises filter regeneration means 40 for selectively initiating a regeneration of the respective filter 12a, 12b when the filter is in the inactive state. In the illustrated example, the filter regeneration means 40 comprise heaters 41a, 41b, which are connected to a respective one of the filters 12a, 12b in order to generate heat to the filter for the initiation of a regeneration thereof, and an air blower 42 for blowing air through the respective heater 41a, 41b and into the filter 12a, 12b associated with the heater, when a regeneration of the filter is to be initiated. The air blower 42 comprises a fan 43, the speed of which being controlled by an electric motor 44 so as to thereby control the temperature of the hot air entering a filter 12a, 12b from the heater 41a, 41b associated therewith when a regeneration of the filter is to be initiated. A valve device 45 is arranged between the fan 43 and the heaters 41a, 41b in order to direct the air flow from the air blower 42 to one of the heaters 41a, 41b while preventing the air flow from the air blower 42 from reaching the other heater. Thus, the valve device 45 is capable of setting one heater 41a, 41b at a time in communication with the air blower 42 while disconnecting the other heater from the air blower.

The respective filter 12a, 12b comprises a first inlet 23a, 23b for receiving exhaust gases from the exhaust conduit 9 and a second inlet 24a, 24b for receiving air from the air blower 42. The respective heater 41a, 41b is connected to the second inlet 24a, 24b of the filter 12a, 12b to which it belongs. A shut-off valve 46a, 46b is arranged between the respective heater 41a, 41b and the second inlet 24a, 24b of the associated filter 12a, 12b. This shut-off valve is open when the associated filter is regenerated. Otherwise, the shut-off valve 46a, 46b is closed so as to prevent unfiltered exhaust gases from entering the heater 41a, 41b during the periods between regeneration operations.

A cooler 25 is arranged between the filters 12a, 12b and the air intake 3 of the engine in order to cool the recirculated exhaust gases. In the illustrated example, the cooler 25 is connected by conduits 26 to the cooling system of the engine 1 so as to be provided with cooling water from this cooling system. A condensate trap 27 is arranged immediately downstream of the cooler 25.

A valve device 28 is arranged in the recirculation system 10 between the filters 12a, 12b and the air intake 3 of the engine, and the recirculation system comprises an electronic control device 29 for controlling the valve device 28 so as to thereby regulate the amount of exhaust gases recirculated to the engine 1. This valve device 28 constitutes a so-called EGR valve. A flow meter 30 is provided for measuring the amount of exhaust gases passing through the recirculation system 10. The control device 29 is connected to this flow meter 30 so as to receive information from it as to the amount of exhaust gases presently recirculated to the engine.

In the illustrated example, secondary filters 31a, 31b are arranged between the valve device 28 and the first outlets 19a, 19b of the recirculation system. A first secondary filter 31a is arranged upstream of one 19a of said first outlets and a second secondary filter 31b is arranged upstream of the other one 19b of these outlets. The secondary filters 31a, 31b have a filtering efficiency that is lower than the filtering efficiency of the particulate filters 12a, 12b and are intended to protect the engine 1 from being damaged by larger particles if the particulate filters 12a, 12b or any other components of the recirculation system 10 would be subjected to failure.

Shut-off valves 32, 33 are provided at the inlet 13 and the second outlet 20 of the recirculation system 10 in order to make it possible to disconnect the recirculation system from the exhaust conduit 9.

The valve devices 18, 21a, 21b, the shut-off valves 32, 33, 46a, 46b, the heaters 41a, 41b, the valve device 45 and the electric motor 44 of the air blower are controlled by the control device 29 or by another electronic control device.

When the recirculation system 10 is in operation, one of the filters, for instance the first filter 12a, is in the active state and consequently connected to the inlet 13 of the recirculation system so as to receive exhaust gases from the exhaust conduit 9, whereas the other filter 12b is in the inactive state and consequently disconnected from the inlet 13. The outlet 22a of the active first filter 12a is connected to the air intake 3 of the engine 1 and disconnected from the second outlet 20 of the recirculation system, whereas the outlet 22b of the inactive second filter 12b is disconnected from the air intake 3 and connected to the second outlet 20. When the active first filter 12a has collected a given amount of particles or when a given period of time has lapsed since this filter was set in the active state, the valve device 18 will disconnect this filter 12a from the inlet 13 and instead connect the second filter 12b to the inlet 13 so as to thereby switch the first filter 12a from active to inactive state and the second filter 12b from inactive to active state. At the same time, the valve device 21a will disconnect the outlet 22a of the first filter 12a from the air intake 3 and instead connect this outlet 22a to the second outlet 20 of the recirculation system, whereas the valve device 21b will disconnect the outlet 22b of the second filter 12b from the second outlet 20 of the recirculation system and instead connect this outlet 22a to the air intake 3. Thereafter, the shut-off valve 46a is opened and the electric motor 44 of the air blower 42 and the heater 41a are switched on so as to thereby initiate a regeneration of the now inactive first filter 12a. The heater 41a heats the air flow from the air blower 42, and the heated air is directed into the filter 12a so as to raise the temperature therein to such a level that combustion of the particles accumulated in the filter will occur. Hereby, the inactive filter 12a is regenerated. The combustion gases formed during the regeneration of the inactive filter 12a will be discharged to the exhaust conduit 9 through the second outlet 20 of the recirculation system. When the regeneration of the inactive filter 12a has been completed, for instance when a given period of time has lapsed since the start of the regeneration process, the electric motor 44 of the air blower and the heater 41a are switched off and the shut-off valve 46a is closed. When the now active second filter 12b has collected a given amount of particles or when a given period of time has lapsed since this filter was set in the active state, the valve device 18 will disconnect this filter 12b from the inlet 13 and instead connect the first filter 12a to the inlet 13 so as to thereby switch the second filter 12b from active to inactive state and the first filter 12a from inactive to active state. At the same time, the valve device 21b will disconnect the outlet 22b of the second filter 12b from the air intake 3 and instead connect this outlet 22b to the second outlet 20 of the recirculation system, whereas the valve device 21a will disconnect the outlet 22a of the first filter 12a from the second outlet 20 of the recirculation system and instead connect this outlet 22b to the air intake 3. Thereafter, the shut-off valve 46b is opened and the electric motor 44 of the air blower 42 and the heater 41b are switched on so as to thereby initiate a regeneration of the now inactive second filter 12b. The combustion gases formed during the regeneration of the inactive filter 12b will be discharged to the exhaust conduit 9 through the second outlet 20 of the recirculation system. When the regeneration of the inactive filter 12b has been completed, the electric motor 44 of the air blower and the heater 41 b are switched off and the shut-off valve 46b is closed.

The above-mentioned operating sequence is repeated as long as the engine 1 is in operation.

The amount of particles accumulated in the active filter may for instance be established by measuring the pressure drop across the filter and the volume flow through the filter.

The exhaust gas recirculation system of the present invention is particularly to be used with a large combustion engine having an engine power of 500 kW or more. Such a combustion engine may for instance be connected to a generator in order to produce electric power in a train or ship or at a power plant.

The invention is of course not in any way restricted to the embodiments described above. On the contrary, many possibilities to modifications thereof will be apparent to a person with ordinary skill in the art without departing from the basic idea of the invention such as defined in the appended claims.

1. An exhaust gas recirculation system for recirculating exhaust gases from an exhaust conduit of a combustion engine, particularly a large combustion engine having an engine power of 500 kW or more, to an air intake thereof, comprising:
a filter arrangement (11) for removing particulate constituents from exhaust gases passing through the recirculation system (10) from the exhaust conduit to the air intake of the engine, the filter arrangement comprising two or more particulate filters (12a, 12b) arranged in parallel with each other;
valve means (17) for selectively switching the respective filter (12a, 12b) between an active state and an inactive state, the valve means (17) being configured to allow exhaust gases to pass from the exhaust conduit to the air intake of the engine through a filter which is in the active state and to prevent exhaust gases from passing from the exhaust conduit to the air intake of the engine through a filter which is in the inactive state; and
filter regeneration means (40) for selectively initiating a regeneration of the respective filter (12a, 12b) when the filter is in the inactive state.

2. An exhaust gas recirculation system according to claim 1, wherein the filter regeneration means (40) comprise heaters (41a, 41b), which are connected to a respective one of said filters (12a, 12b) to generate heat to the filter for the initiation of a regeneration thereof.

3. An exhaust gas recirculation system according to claim 2, wherein the filter regeneration means (40) comprise an air blower (42) for blowing air through the respective heater (41a, 41b) and into the filter (12a, 12b) associated with the heater, when a regeneration of the filter is to be initiated.

4. An exhaust gas recirculation system according to claim 3, wherein the air blower (42) comprises a fan (43), the speed of which being controlled by an electric motor (44) to thereby control the temperature of the hot air entering a filter (12a, 12b) from the heater (41a, 41b) associated therewith when a regeneration of the filter is to be initiated.

5. An exhaust gas recirculation system according to claim 3, wherein the respective filter (12a, 12b) comprises a first inlet (23a, 23b) for receiving exhaust gases from the exhaust conduit (9) and a second inlet (24a, 24b) for receiving air from the air blower (42), the respective heater (41a, 41b) being connected to the second inlet (24a, 24b) of the filter to which it belongs.

6. An exhaust gas recirculation system according to claim 1, wherein a cooler (25) is arranged between the filters (12a, 12b) and the air intake of the engine to cool the recirculated exhaust gases.

7. An exhaust gas recirculation system according to claim 6, wherein a condensate trap (27) is arranged between the cooler (25) and the air intake of the engine.

8. An exhaust gas recirculation system according to claim 1, comprising:
an inlet (13) for receiving exhaust gases from the exhaust conduit of the engine;
one or more first outlets (19a, 19b) connected to the air intake of the engine for discharging recirculated exhaust gases to the air intake; and
one or more second outlets (20) connected to the exhaust conduit of the engine downstream of the inlet (13) for discharging combustion gases produced during the regeneration of the respective filter (12a, 12b) to the exhaust conduit.

9. An exhaust gas recirculation system according to claim 8, wherein the inlet (13) of the recirculation system (10) comprises a pick-up tube (14), which is arranged in the exhaust conduit of the engine with its inlet opening (15) directed against the intended flowing direction of exhaust gases flowing through the exhaust conduit.

10. An exhaust gas recirculation system according to claim 8, wherein a valve device (21a, 21b) is arranged downstream of the respective filter (12a, 12b) to selectively set the outlet (22a, 22b) of the filter in communication with at least one of said one or more first outlets (19a, 19b) or second outlets (20) of the recirculation system.

11. An exhaust gas recirculation system according to claim 1, comprising a valve device (28) arranged between the filters (12a, 12b) and the air intake of the engine, and an electronic control device (29) for controlling the valve device (28) so as to thereby regulate the amount of exhaust gases recirculated to the engine.

12. An exhaust gas recirculation system according to claim 1, wherein said valve means (17) are configured to switch at least one of said filters (12a, 12b) from active to inactive state while simultaneously switching at least another one of said filters (12a, 12b) from inactive to active state.

13. An exhaust gas recirculation system according to claim 4, wherein the respective filter (12a, 12b) comprises a first inlet (23a, 23b) for receiving exhaust gases from the exhaust conduit (9) and a second inlet (24a, 24b) for receiving air from the air blower (42), the respective heater (41a, 41b) being connected to the second inlet (24a, 24b) of the filter to which it belongs.

14. An exhaust gas recirculation system according to claim 13, wherein a cooler (25) is arranged between the filters (12a, 12b) and the air intake of the engine to cool the recirculated exhaust gases.

15. An exhaust gas recirculation system according to claim 5, wherein a cooler (25) is arranged between the filters (12a, 12b) and the air intake of the engine to cool the recirculated exhaust gases.

16. An exhaust gas recirculation system according to claim 4, wherein a cooler (25) is arranged between the filters (12a, 12b) and the air intake of the engine to cool the recirculated exhaust gases.

17. An exhaust gas recirculation system according to claim 3, wherein a cooler (25) is arranged between the filters (12a, 12b) and the air intake of the engine to cool the recirculated exhaust gases.

18. An exhaust gas recirculation system according to claim 2, wherein a cooler (25) is arranged between the filters (12a, 12b) and the air intake of the engine to cool the recirculated exhaust gases.

19. An exhaust gas recirculation system according to claim 14, wherein a condensate trap (27) is arranged between the cooler (25) and the air intake of the engine.

20. An exhaust gas recirculation system according to claim 15, wherein a condensate trap (27) is arranged between the cooler (25) and the air intake of the engine.
